(19) United States
(12) Patent Application Publication
(10) Pub. No.: US 2003/0085803 A1
(43) Pub. Date: May 8, 2003

(54) Method and configuration for providing power to personal computer, computer workstations and the like

(76) Inventor: Kishor Bapat, Newbury Park, CA (US)

Correspondence Address: Bierman, Muserlian and Lucas LLP, 600 Third Avene, New York, NY, 10016, US

(21) Appl. No.: 10/217,901

(22) Filed: Aug. 13, 2002

Related U.S. Application Data
(60) Provisional application No. 60/311,976, filed on Aug. 13, 2001.

(51) Int. Cl. G08B 1/00

(52) U.S. Cl. 340/333

(57) ABSTRACT

Method and apparatus for remotely supplying power to devices to consume less power.

This invention relates to a method and configuration for providing power to personal computer, computer workstations and the like.

### FIELD OF THE INVENTION

This invention broadly relates to the powering of personal computers, workstations and similar low power devices. The invention more particularly relates to the reduction in power consumption of these devices and to the reduction in the amount of electrical wiring required to use these computers. It also relates to elimination of floor wiring in the construction of new buildings.

### BACKGROUND OF THE INVENTION

Millions of personal computers are in use today. Most of these computers are connected to electric wail sockets using electric cords. These computers also consume inordinate amounts of electric Dower. They also occupy a lot of space in offices and homes.

### SUMMARY OF THE INVENTION

According to this invention there is provided a system and method for powering desktop computers and monitors without using electrical cords, characterized in that power to operate the computer and monitor is carried by standard data cables from a data and power distribution means such as a network hub or network switch or patch panel.

A principal feature of the invention is a modified hub/switch/patch panel, that provides electric power in addition to the data.

Other important features of this invention is a network connector that eliminates the power flow to computers in a network that still get their power locally and to the cable that connects the hub/switch/panel to the central network.

An object of this invention is to provide a:

i) a custom designed device (hub/switch/patch panel) that provides both data and sufficient electric current to power as many personal computers as there are ports on this device

ii) computers and monitors that consume very little power (approximately 50 watts) and

iii) a special network connector to protect those devices that cannot accept the supplied power

Another object of this invention is to reduce power consumption of computers and eliminate the need for power cords at each desktop location.

### DRAWINGS

The invention will be more clearly understood by reference to the following description, taken in connection with the accompanying drawings, in which:

FIG. 1 is a simplified schematic diagram of the invention

FIG. 2 is a simplified schematic drawing of a rewired ethernet hub

FIG. 3 is a simplified schematic drawing of the power and data separation circuitry within the personal computer, and

FIG. 4 is a simplified schematic diagram of the special network connector.

FIG. 5 is another embodiment of the invention; and

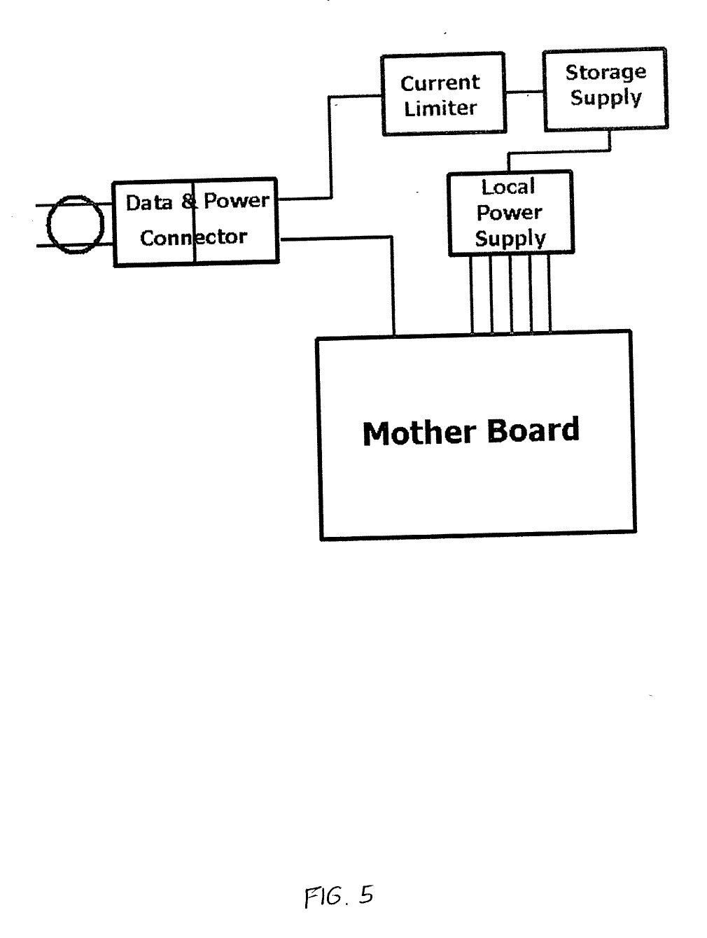

FIG. 6 is another embodiment of the invention.

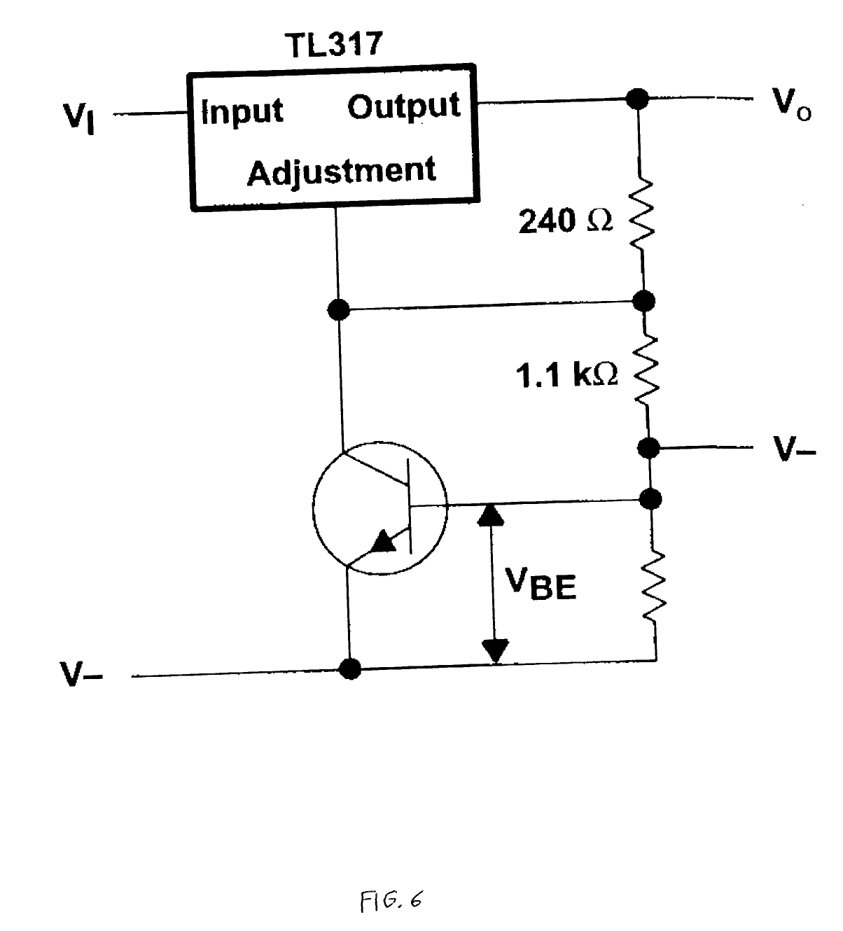

### DESCRIPTION OF THE PREFERRED EMBODIMENT

Referring to the drawings

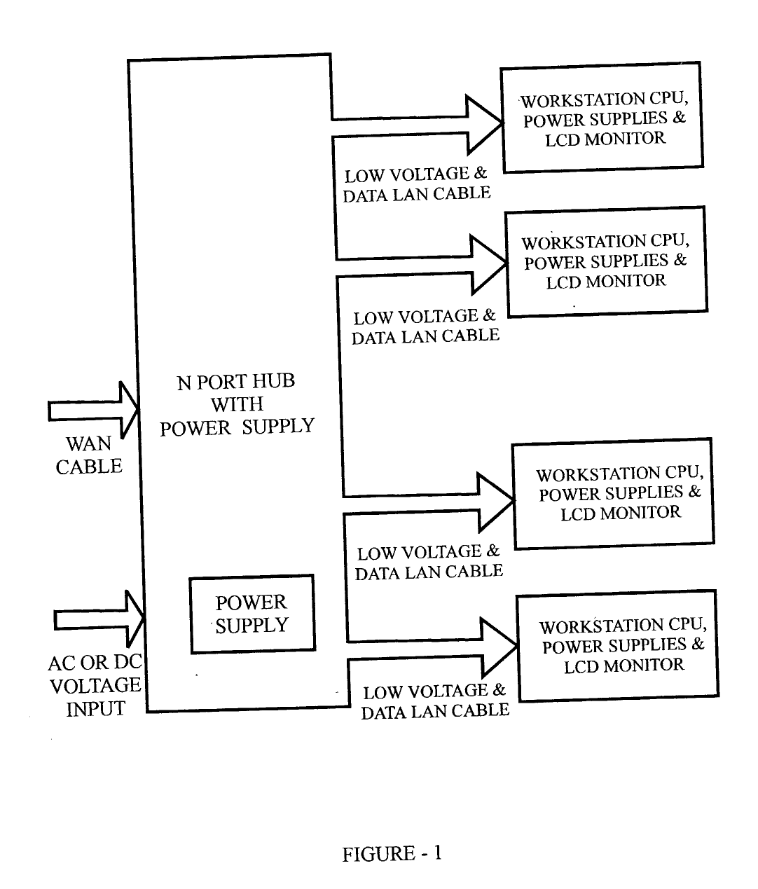

FIG. 1 is a block diagram which illustrates describes the general concept/method behind this invention for reducing power consumption of computers and eliminating the need for power cords at each desktop location.

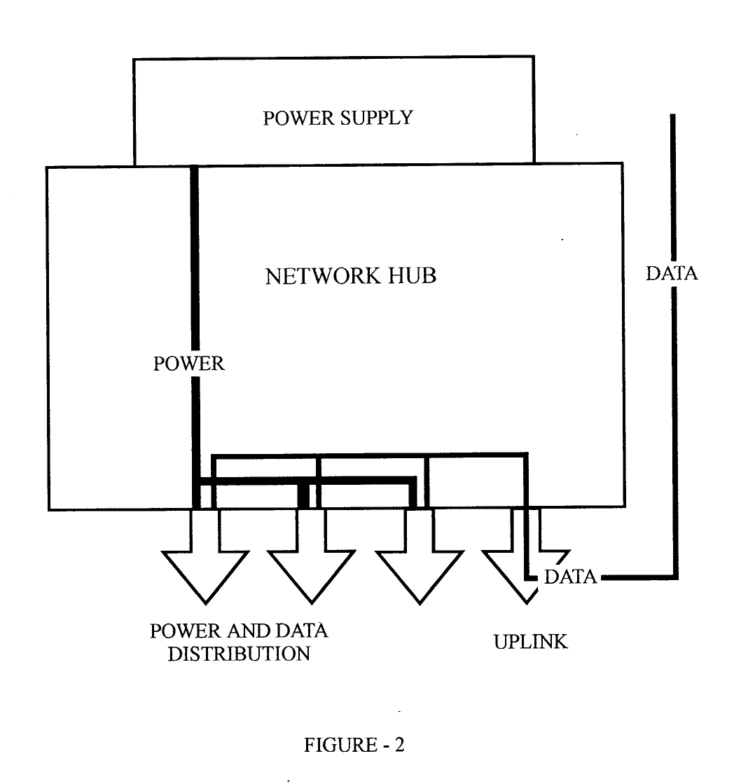

FIG. 2 is a block schematic diagram which depicts a network hub that is modified to supply power to the normally unused wires coming out of the hub. It is envisaged that in accordance with an alternative embodiment of this invention a network switch or a patch panel can be used instead of the hub.

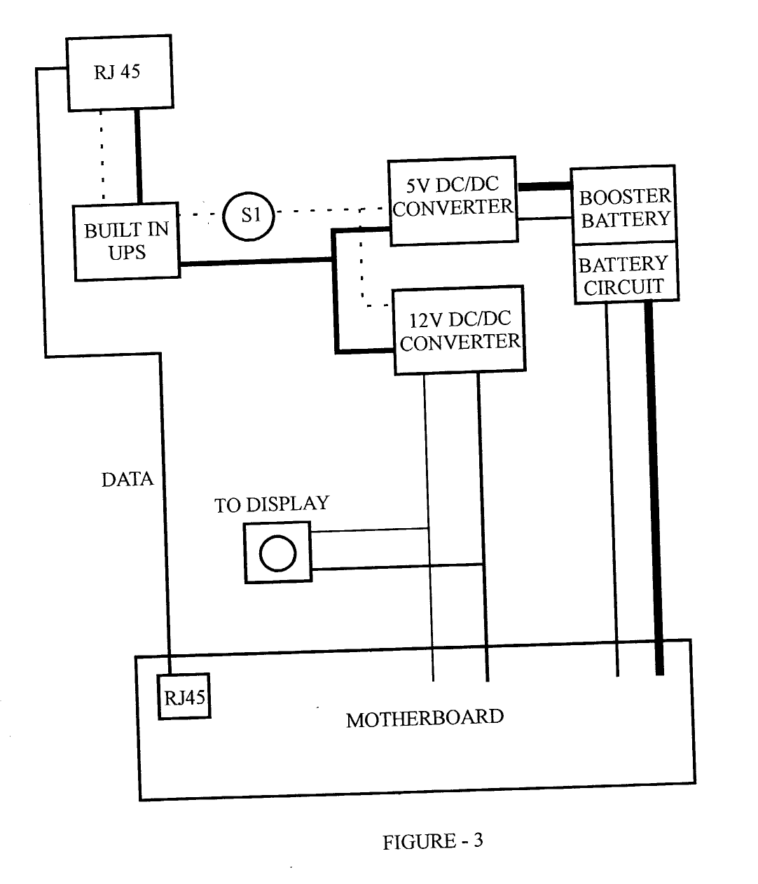

Referring now to FIG. 3. The figure shows a personal computer that contains supplies to convert voltages to the power requirements of the computer. The computer also contains batteries to supply reserve power when required by the device and to serve as a power source in case of a power failure. This device also contains an outlet used to power a monitor.

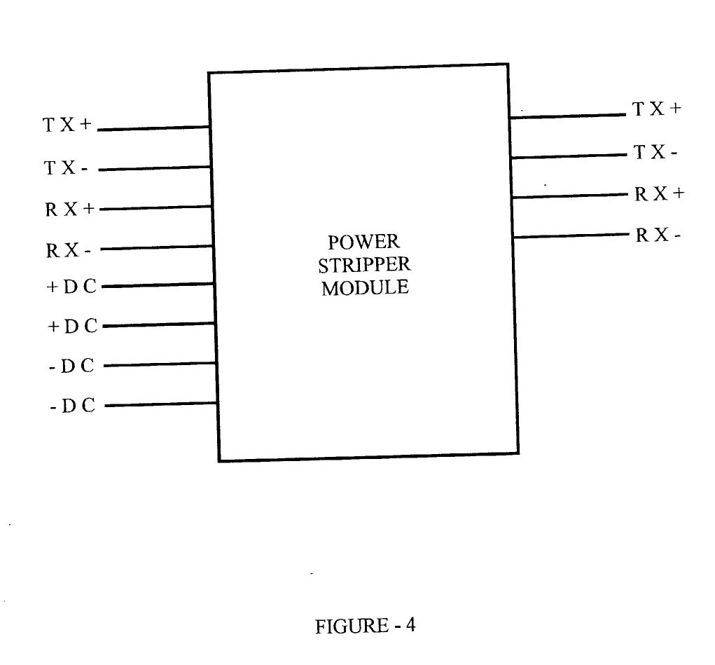

Referring now to FIG. 4. This figure illustrates a connector used to ensure that power will not be supplied to a device, if it is so desired.

Thus this invention provides a method and apparatus for remotely supplying power to devices that typically consume low power such as personal computers, low power monitors, laptop computers, computer terminals and similar devices said apparatus consisting of

a device (hub/switch/patch panel) containing an ac/dc power supply or an a/c transformer for selectively injecting electric power into the network wires that are not used for data transmission,

low power personal computers containing dc/dc power converters to power all the devices within the unit and a connector for powering a low power monitor,

a device for removing electric current from the system for connections that do not need electric current

Although the invention has been described in terms of particular embodiments and applications, one of ordinary skill in the art, in light of this teaching, can generate additional embodiments and modifications without departing from the spirit of or exceeding the scope of the invention. For instance, the apparatus can also contain diskless workstations instead of personal computers.

Accordingly, it is to be understood that the drawings and descriptions herein are proffered by way of example to facilitate comprehension of the invention and should not be construed to limit the scope thereof.

### CROSS-REFERENCE TO RELATED APPLICATION

Reference is made to prior copending U.S. provisional patent application No. 60/311,976, filed Aug. 13, 2001, by the inventor of the present invention. Such application is incorporated herein by reference.

What is claimed is:

1. A system for providing electrical power to a plurality of networked low-power devices through data communication lines, comprising:
a network hub including a power supply, a first input port, a second input port and a plurality of output ports;
the first input port configured to receive electrical power from an external source;
the second input port configured to receive data from an external wide area network cable; and
each output port configured to provide both electrical power and data to the low-power devices.

2. The system of claim 1, in which at least one low-power device is a personal computer.

3. The system of claim 1, in which at least one low-power device is a monitor.

4. The system of claim 1, in which the network hub includes an AC to DC converter for supplying DC power to a plurality of personal computers coupled to the network hub via the output ports.

5. The system of claim 1, in which at least one output port is coupled to a network connector to protect low-power devices that cannot be configured to receive electrical power via the output port.

6. The system of claim 2, in which each personal computer includes a DC to DC power converter to provide electrical power to a motherboard of each personal computer.

7. The system of claim 6, in which the DC to DC power converter also provides electrical power to a low-power monitor.
